(19) United States
(12) Patent Application Publication
(10) Pub. No.: US 2010/0111470 A1
(43) Pub. Date: May 6, 2010

(54) LOW-LOSS LOW-CROSSTALK INTEGRATED DIGITAL OPTICAL SWITCH

(75) Inventors: Solomon Assefa, Ossining, NY (US); William M. Green, Astoria, NY (US); Younghee Kim, Mohegan Lake, NY (US); Joris Van Campenhout, Grimbergen (BE); Yurii Vlasov, Katonah, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/265,938

(22) Filed: Nov. 6, 2008

(51) Int. Cl. G02B 6/26

(52) U.S. Cl. 385/16

(57) ABSTRACT

An optical switch includes a plurality of optical interferometric structures is serially connected between at least one optical input node and two optical output nodes. A primary waveguide directly connects an optical input node and a first optical output node. A complementary waveguide, which is directly connected to a second optical output node, is evanescently coupled with the primary waveguide in a pair of optically coupled sections provided in each optical interferometric structure. Each optical interferometric structure also includes a pair of decoupled sections, which includes a primary decoupled section embedding a portion of the primary waveguide and a complementary decoupled section which includes a portion of the complementary waveguide. The complementary decoupled section is embedded in a phase tuning structure that allows modulation of the phase of the optical signal passing through. The optical switch provides less insertion loss, less crosstalk, and wider bandwidth than prior art optical switches.

### FIELD OF THE INVENTION

The present invention relates to a semiconductor structure, and particularly to a digital optical switch based on Mach-Zehnder lattice, and methods of operating the same.

### BACKGROUND OF THE INVENTION

Nanophotonics is a rapidly developing field in which state of art nanoscale devices are employed to manipulate light. A typical nanophotonics chip enables interaction of optical signals with electrical signals. For example, the nanophotonics chip may generate optical signal based on electrical signals or route the optical signals into selected output ports or convert the optical signals into electrical signals.

Fiber optic cables are typically employed to transmit the optical signal from or into the nanophotonics chip. The fiber optic cables may be connected to the nanophotonics chip, for example, through fiber couplers. The nanophotonics chip includes signal pins for power supply and electrical input/output ports and at least one optical input port and/or at least one optical output port. In many cases, the nanophotonics chip includes multiple optical input ports and multiple optical output ports. Additional components of the nanophotonics chip may include optical modulators, optical switches, optical delay lines, photonic wires for conducting the light signal, and other conventional semiconductor devices for processing electrical signals or for affecting the operation of optical components in the nanophotonics chip.

Optical switches are employed in a nanophotonics chip to enable changing of optical signal paths. Ideally, an optical switch should have a switching capability over a broad optical bandwidth, i.e., over a wide range of optical wavelength. A low switching power, i.e., low energy consumption per operation, is preferred. Low insertion loss, i.e., reduction of optical signal due to the presence of the optical switch, is preferred in the on state and off state. Also, a digital response is preferred instead of an analog response to relax requirements on the driving signal for the switching operation. In addition, a compact footprint for the nanophotonics chip is also required.

Referring to FIG. 1, an exemplary prior art optical switch employs an optical interferometric structure 10′ to provide optical switching. The exemplary prior art optical switch includes a first optical input node 101′, a second optical input node 201′, a first optical output node 199′, and a second optical output node 299′. A primary waveguide 100′ connects the first optical input node 101′ to the first optical output node 199′. A complementary waveguide 200′ connects the second optical input node 201′ to the second optical output node 299′.

A first pair of optically coupled sections 8′ and a second pair of optically coupled sections 18′ are provided within the optical interferometric structure 10′ to provide some means of optical coupling, such as “evanescent coupling” between the primary waveguide 100′ and the complementary waveguide 200′. Typically, each of the first pair of optically coupled sections 8′ and a second pair of optically coupled sections 18′ includes a portion of the primary waveguide 100′ and a portion of the complementary waveguide 200′ that are placed in parallel and in proximity to each other to enable optical coupling for the light between the two portions. Specifically, the first pair of optically coupled sections 8′ includes a first primary coupling section 108′ and a first complementary coupling section 208′, and the second pair of optically coupled sections pair of optically coupled sections 18′ includes a second primary coupling section 118′ and a second complementary coupling section 218′.

The optical interferometric structure 10′ further includes a pair of decoupled sections 12′, which includes a primary decoupled section 112′ and a complementary decoupled section 212′. The complementary decoupled section 212′ is embedded in a phase tuning structure 13′.

The functional characteristics of the exemplary prior art optical switch of FIG. 1 may be described as a 2×2 optical signal switch shown in FIG. 2. The fraction of a first input signal applied to the first optical input node 101′ that is transmitted to the first output signal node 199′ is represented by a first bar transmission coefficient T₁₁, and the fraction of the first input signal applied to the first optical input node 101′ that is transmitted to the second output signal node 299′ is represented by a first cross transmission coefficient T₁₂. The fraction of a second input signal applied to the second optical input node 201′ that is transmitted to the first output signal node 199′ is represented by a second cross transmission coefficient T₂₁, and the fraction of the second input signal applied to the second optical input node 101′ that is transmitted to the second output signal node 299′ is represented by a second bar transmission coefficient T₂₂.

The various transmission coefficients may be modulated by altering the phase change of the optical signal in the complementary decoupled section 212′. The first cross transmission coefficient T₁₂ is illustrated here. For the first input signal applied to the first optical input node 101′ and having a predetermined wavelength, the optical path from the first optical input node 101′ to the second optical output node 299′ includes two optical paths. A first optical path includes the first optical input node 101′, the first primary coupling section 108′, the primary decoupled section 112′, the second primary coupling section 118′, the second complementary coupling section 218′, and the second optical output node 299′. A second optical path includes the first optical input node 101′, the first primary coupling section 108′, the first complementary coupling section 208′, the complementary decoupled section 212′, the second complementary coupling section 218′, and the second optical output node 299′. The phase change of the optical signal through the first optical path is independent of changes of refractive index in the phase tuning structure 13′. The phase change of the optical signal through the second optical path depends on that change in the refractive index in the phase tuning structure 13′ triggered by the external control signal.

In general, by modulating the phase changes of the optical signal through the second optical path, a constructive interference or a destructive interference may be induced between the optical signal through the first optical path and the second optical path. In one example, the total length of the first pair of optically coupled sections 8′ and a second pair of optically coupled sections 18′ as well as the separation between the primary and complementary coupling sections (108′, 208′, 118′, 218′) may be employed to tune whether constructive interference or destructive interference is induced in the absence of the electrical control signal applied to the phase tuning structure 13′.

Referring to FIG. 3, the result of a simulation of for the first bar transmission coefficient T₁₁ and the first cross transmission coefficient T₁₂ is shown for the exemplary prior art optical switch of FIG. 1 for the case of an optical signal having a wavelength of 1.55 microns and the phase shifter 212′ having a length of 500 microns. The primary waveguide 100′ and the complementary waveguide 200′ are embedded in silicon and the phase tuning structure 13′ is embedded in an intrinsic silicon portion of a PIN (p-type-intrinsic-n-type) diode. The carrier concentration of the phase tuning structure 13′ is controlled by changing the current through the PIN diode. For example, by changing the carrier concentration in the phase tuning structure, the optical input signal applied to the first optical input node 101′ may be routed predominantly to the second optical output node 299′ when the carrier concentration is substantially zero, or may be routed predominantly to the first optical output node 199′ when the carrier concentration is about 0.6×10¹⁸/cm³.

The transmission coefficients of the exemplary prior art optical switch demonstrate the difficulty in manufacturing and operation. First, the transmission coefficients of the exemplary prior art optical switch change rapidly with the carrier concentration. Changes in processing parameters during manufacturing may lead to variations in the carrier concentration from chip to chip, thereby degrading the performance of the exemplary prior art optical switch. For example, when the optical input signal is intended to be routed from the first optical input node 101′ to the first optical output node 199′, the first cross transmission coefficient T₁₂ may change depending on the exact carrier concentration around 0.6×10¹⁸/cm³. Further, small changes in the wavelength of the optical input signal from the target value may significantly increase the crosstalk between the channels. In addition, the signal loss becomes non-negligible even for the first bar transmission coefficient T₁₁ as the carrier concentration increases.

In view of the above, there exists a need for an optical switch that may be integrated into a nanophotonics chip and provides low loss and low crosstalk and good tolerance to fluctuations on the control signal, i.e., digital switching response, and methods of operating the same.

### SUMMARY OF THE INVENTION

The present invention provides a low-loss low-crosstalk integrated digital optical switch based on Mach-Zehnder lattice, and methods of operating the same.

An optical switch of the present invention includes a plurality of optical interferometric structures which are serially connected between at least one optical input node and two optical output nodes. A primary waveguide directly connects an optical input node and a first optical output node. A complementary waveguide, which is directly connected to a second optical output node, is coupled, i.e., evanescently, with the primary waveguide in a pair of optically coupled sections provided in each optical interferometric structure. Each optical interferometric structure also includes a pair of decoupled sections, which includes a primary decoupled section embedding a portion of the primary waveguide and a complementary decoupled section which includes a portion of the complementary waveguide. The complementary decoupled section is embedded in a phase tuning structure that allows modulation of the phase of the optical signal passing through. The optical switch provides less insertion loss, less crosstalk and improved tolerance to variations on the control signal

According to an aspect of the present invention, an optical switch is provided, which includes: a primary waveguide embedded in a semiconductor substrate and directly connected to a first optical input node and a first optical output node; a complementary waveguide embedded in the semiconductor substrate and directly connected to a second optical output node; and a plurality of optical interferometric structures, wherein each optical interferometric structure includes a pair of optically coupled sections and a pair of decoupled sections, wherein a section of the primary waveguide is evanescently coupled to a section of the complementary waveguide in the pair of optically coupled sections, and wherein optical signals are not evanescently coupled across the primary waveguide and the complementary waveguide in the pair of decoupled sections.

According to another aspect of the present invention, a method of operating an optical switch is provided, which comprises: providing an optical switch including: a primary waveguide embedded in a semiconductor substrate and directly connected to a first optical input node and a first optical output node; a complementary waveguide embedded in the semiconductor substrate and directly connected to a second optical output node; and a plurality of optical interferometric structures, wherein each optical interferometric structure includes a pair of optically coupled sections and a pair of decoupled sections, wherein a section of the primary waveguide is evanescently coupled to a section of the complementary waveguide in the pair of optically coupled sections, and wherein optical signals are not evanescently coupled across the primary waveguide and the complementary waveguide in the pair of decoupled sections; and modulating phase change of an optical signal in the complementary waveguide by altering a refractive index of a semiconductor material in a plurality of pair of optically coupled sections.

### BRIEF DESCRIPTION OF THE DRAWINGS

FIG. 1 is a top-down view of an exemplary prior art optical switch.

FIG. 2 is a functional schematic of the exemplary prior art optical switch.

FIG. 3 is a graph of the bar transmission characteristics and cross transmission characteristics of the exemplary prior art optical switch of FIG. 1.

FIG. 4 is a top-down view of a first exemplary optical switch having four stages of optical interferometric structures according to a first embodiment of the present invention.

FIG. 5 is a vertical cross-sectional view of the first exemplary optical switch according to the first embodiment of the present invention.

FIG. 6 is a graph of the bar transmission characteristics and cross transmission characteristics of an optical switch having two stages of optical interferometric structures according to the present invention.

FIG. 7 is a graph of the bar transmission characteristics and cross transmission characteristics of an optical switch having 9 stages of optical interferometric structures according to the present invention.

FIG. 8 is a graph showing simulation results for the ratio T₁₁/T₁₂ for an optical switch having two stages of optical interferometric structures for a non-phase-tuned state and for a phase tuned state as a function of wavelength.

FIG. 9 is a graph showing measured data for the ratio T₁₁/T₁₂ for an optical switch having two stages of optical interferometric structures for a non-phase-tuned state and for a phase tuned state as a function of wavelength.

FIG. 10 is a top-down view of a second exemplary optical switch having four stages of optical interferometric structures according to a second embodiment of the present invention.

### DETAILED DESCRIPTION OF THE INVENTION

As stated above, the present invention relates to a low-loss low-crosstalk integrated digital optical switch based on Mach-Zehnder lattice and methods of operating the same, which are now described in detail with accompanying figures. Throughout the drawings, the same reference numerals or letters are used to designate like or equivalent elements. The drawings are not necessarily drawn to scale.

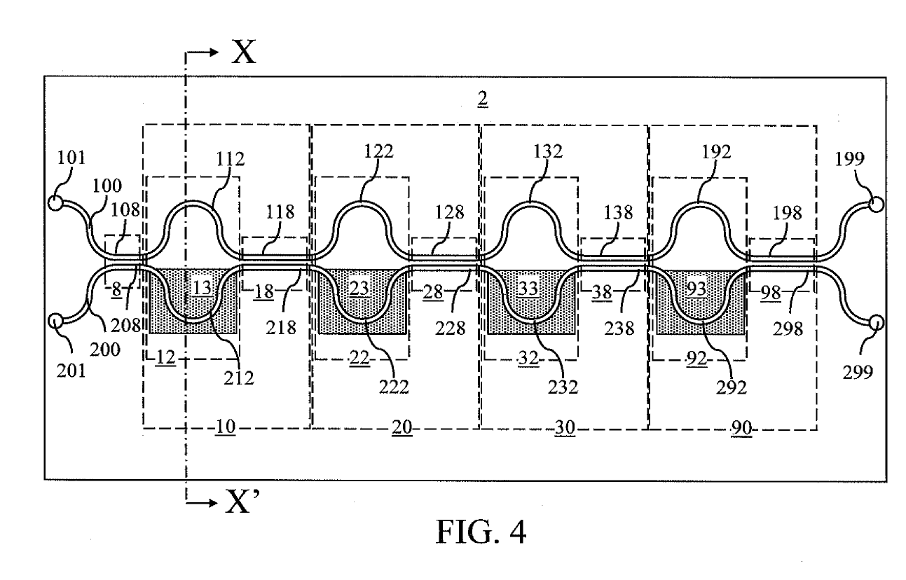

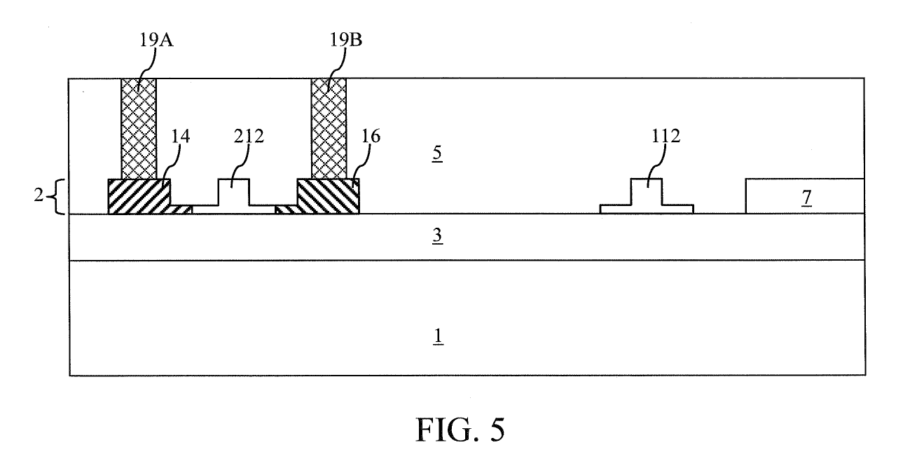

Referring to FIGS. 4 and 5, a first exemplary optical switch according to a first embodiment of the present invention is shown. FIG. 4 is top-down view long a horizontal plane intersecting a primary waveguide 100 and a complementary waveguide 200 in FIG. 5. FIG. 5 is a vertical cross-sectional view along a vertical plane X-X′ in FIG. 4. The first exemplary optical switch includes a plurality of optical interferometric structures, which include a first optical interferometric structure 10, a second optical interferometric structure 20, a third optical interferometric structure 30, and an n-th optical interferometric structure 90. The n-th optical interferometric structure 90 represents the last optical interferometric structure in a cascaded sequence of optical interferometric structures.

Any number of additional interferometric structures may be added between the third optical interferometric structure 30 and the n-th optical interferometric structure 90. Conversely, the second optical interferometric structure 20 and/or the third optical interferometric structure 30 may be removed from the first exemplary optical switch. While the first embodiment of the present invention is described employing the first exemplary optical switch that includes four serially connected optical interferometric structures, the present invention may be practiced with a plurality of optical interferometric structures in which the number of the interferometric structure units is any positive integer greater than 1, i.e., 2 or any integer greater than 2.

In one embodiment, the interferometric structures may be replicas of an optical interferometric structure 10. In another embodiment, the interferometric structures are not identical among one another. For example, the length of the coupling sections can be different among the interferometric structures. The actual distribution of the individual lengths of the coupling sections has a strong impact on the switching characteristics, i.e the position and amplitude of the switching sidelobes. The distribution of the coupling lengths can be done according to a window function, which can be rectangular, Gaussian, Hamming or other, in order to obtain the desired switching response. Furthermore, each interferometric structure can incorporate a specific phase delay between the waveguides of the decoupled section, in order to tailor the spectral response (bandwidth) of the switch. This phase delay can be implemented through a length difference of the waveguides in the decoupled section of the interferometric structure of interest.

Each of the first through n-th optical interferometric structures (10, 20, 30, 90) constitute a Mach-Zehnder interferometric structure in which the phase of the light signal through a portion of the complementary waveguide 200 may be modulated. The present invention employs a cascaded plurality of Mach-Zehnder interferometric structures that are connected in a series connection employing the same primary waveguide 100 and the same complementary waveguide 200. In case each of the Mach-Zehnder interferometric structures is identical to other Mach-Zehnder interferometric structures, the cascaded plurality of Mach-Zehnder interferometric structures constitutes a periodic structure, i.e., a periodic one dimensional array of Mach-Zehnder interferometric structures, or a “Mach-Zehnder lattice.”

The cascaded plurality of Mach-Zehnder interferometric structures constitutes a periodic structure provides a distinctive optical transmission characteristics which may be advantageously employed to provide a superior performance as an optical switch having low insertion loss, reduced crosstalk, and digital switching characteristics.

The first exemplary optical switch includes a first optical input node 101, a second optical input node 201, a first optical output node 199, and a second optical output node 299. A primary waveguide 100 connects the first optical input node 101 to the first optical output node 199. A complementary waveguide 200 connects the second optical input node 201 to the second optical output node 299. The first optical input node 101, the second optical input node 201, the first optical output node 199, and the second optical output node 299 are symbolically represented by circles in FIGS. 4 and 5. Each of the first optical input node 101, the second optical input node 201, the first optical output node 199, and the second optical output node 299 is an end portion of a primary waveguide 100 or a complementary waveguide 200 that is configured to facilitate a physical connection to a fiber coupler so that optical signal may be received from or transmitted into an optical cable. The input- and output-ports may also be connected to other on-chip optical devices.

Each of the primary waveguide 100 and the complementary waveguide 200 is embedded in a semiconductor layer 2. The semiconductor layer 2 may be a top semiconductor layer of a semiconductor-on-insulator (SOI) substrate including a handle substrate 1, a buried insulator layer 3, and the top semiconductor layer 2. The top semiconductor layer 2 includes the primary waveguide 100, the complementary waveguide 200, and semiconductor device portions 7 in which field effect transistors or other semiconductor devices may be formed. A dielectric material layer 5 comprising a dielectric material such as silicon oxide and/or silicon nitride is typically formed over the semiconductor layer 2.

The primary waveguide 100 is contiguous between the first optical input node 101 and the first optical output node 199. The complementary waveguide 200 is contiguous between the second optical input node 201 and the second optical output node 299. Typically, the primary waveguide 100 has a substantially constant cross-sectional area between the first optical input node 101 and the first optical output node 199, and the complementary waveguide 200 has a substantially constant cross-sectional area between the second optical input node 201 and the second optical output node 299.

The semiconductor layer 2 comprises a semiconductor material. Non-limiting examples of the semiconductor material includes silicon, germanium, silicon-germanium alloy, silicon carbon alloy, silicon-germanium-carbon alloy, gallium arsenide, indium arsenide, indium phosphide, III-V compound semiconductor materials, II-VI compound semiconductor materials, organic semiconductor materials, and other compound semiconductor materials. The semiconductor layer 2 may comprise a polycrystalline semiconductor material, an amorphous semiconductor material, or a single crystalline semiconductor material. Preferably, the primary waveguide 100 and the complementary waveguide 200 comprise the same semiconductor material as the semiconductor layer 2. In this case, the primary waveguide 100 and the complementary waveguide 200 may be formed by patterning the semiconductor layer 2.

Preferably, the semiconductor layer 2 comprises a single crystalline semiconductor layer, and the primary waveguide 100 and the complementary waveguide 200 comprise the same single crystalline semiconductor material as the single crystalline semiconductor layer. In this case, the primary waveguide 100 and the complementary waveguide 200 are embedded in the single crystalline silicon layer, and each of the primary waveguide 100 and the complementary waveguide 200 comprise a same semiconductor material as the semiconductor layer 2.

Each of the primary waveguide 100 and the complementary waveguide 200 may be formed by patterning a semiconductor layer having a substantially coplanar bottom surface and a substantially coplanar top surface. In this case, an entirety of a bottom surface of the primary waveguide 100 and an entirety of a bottom surface of the complementary waveguide 200 are coplanar with each other, and an entirety of a top surface of the primary waveguide 100 and an entirety of a top surface of the complementary waveguide 200 are coplanar with each other.

Each optical interferometric structure (10, 20, 30, 90) includes a pair of decoupled sections and a pair of optically coupled sections. The first optical interferometric structure 10 includes a first decoupled section 12 and a first pair of optically coupled sections 18. The second optical interferometric structure 20 includes a second decoupled section 22 and a second pair of optically coupled sections 28. The third optical interferometric structure 30 includes a third decoupled section 32 and a third pair of optically coupled sections 38. The n-th optical interferometric structure 90 includes an n-th decoupled section 92 and an n-th pair of optically coupled sections 98.

Each pair of optically coupled sections (18, 28, 38, 98) includes a portion of the primary waveguide 100 and a portion of a complementary waveguide 200. Specifically, the first pair of optically coupled sections 18 includes a first primary coupling section 118 which is a portion of the primary waveguide 100 and a first complementary coupling section 218 which is a portion of the complementary waveguide 200. The second pair of optically coupled sections 28 includes a second primary coupling section 128 which is a portion of the primary waveguide 100 and a second complementary coupling section 228 which is a portion of the complementary waveguide 200. The third pair of optically coupled sections 18 includes a third primary coupling section 138 which is a portion of the primary waveguide 100 and a third complementary coupling section 238 which is a portion of the complementary waveguide 200. The n-th pair of optically coupled sections 98 includes an n-th primary coupling section 198 which is a portion of the primary waveguide 100 and an n-th complementary coupling section 298 which is a portion of the complementary waveguide 200.

Optionally, an initial pair of optically coupled sections 8 may be provided between the first and second optical input nodes (101, 201) and the first decoupled section 12. The initial pair of optically coupled sections 8 includes an initial primary coupling section 108 which is a Portion of the primary waveguide 100 and an initial complementary coupling section 208 which is a portion of the complementary waveguide 200. The initial coupling section 8, if provided, induces additional coupling of the optical signal between the primary waveguide 100 and the complementary waveguide 200.

The length of each pair of the optically coupled sections (8, 18, 28, 38, 98) may be independently controlled. In one embodiment, all pairs of the optically coupled sections (8, 18, 28, 38, 98) have the same length. In another embodiment, at least one of the optically coupled sections (8, 18, 28, 38, 98) have a different length. Changes in the lengths of the individual pair of the optically coupled sections (8, 18, 28, 38, 98) may be advantageously employed to engineer the location and the peak height of sidelobes in the transmission characteristics of the first exemplary optical switch.

In each pair of optically coupled sections (8, 18, 28, 38, 98), the portion of the primary waveguide 100 in that pair of optically coupled sections and the portion of the complementary waveguide 200 in that pair of optically coupled sections are located to provide light coupling between them. Typically, the portion of the primary waveguide 100 in that pair of optically coupled sections and the portion of the complementary waveguide 200 are placed in parallel and in proximity to each other within each pair of optically coupled sections to enable quantum mechanical coupling for the light between the two portions. Specifically, quantum mechanical coupling is provided between the initial primary coupling section 108 and the initial complementary coupling section 208, between the first primary coupling section 118 and the first complementary coupling section 218, between the second primary coupling section 128 and the second complementary coupling section 228, between the third primary coupling section 138 and the third complementary coupling section 238, between the n-th primary coupling section 198 and the n-th complementary coupling section 298, respectively. Typically, the separation distance between the two parallel portions within each pair of optically coupled sections is on the order of the a quarter wavelength of the light in the medium located between the two waveguide portions. The separation distance affects the required length of the coupling sections, but also the optical bandwidth. While, a small coupling gap yields strong coupling, with a wide optical bandwidth, coupling through coupling sections with small gaps tend to be sensitive to process variations during manufacturing.

In each pair of optically coupled sections (108, 118, 128, 138, 198), a section of the primary waveguide 100 may be separated from the matching section of the complementary waveguide 200 by a substantial constant separation distance. The substantially constant separation distance depends on the wavelength of the optical signal, which typically has a wavelength from 1.2 microns to 3.0 microns as measured in vacuum. In such cases, the substantially constant separation distance may be from 0 micron to 1,000 micron, and preferably from 100 nm to 500 nm, although lesser and greater separation distances are also contemplated herein.

Each of the pair of decoupled sections (12, 22, 32, 92) includes a primary decoupled section which is a portion of the primary waveguide 100 and a complementary decoupled section which is a portion of the complementary waveguide 200. Specifically, the first pair of decoupled section 12 includes a first primary decoupled section 112 and a first complementary decoupled section 212, the second pair of decoupled section 22 includes a second primary decoupled section 122 and a second complementary decoupled section 222, the third pair of decoupled section 32 includes a third primary decoupled section 132 and a third complementary decoupled section 232, and the n-th pair of decoupled section 92 includes an n-th primary decoupled section 192 and an n-th complementary decoupled section 292, respectively. Each of the complementary decoupled sections (212, 222, 232, 292) is embedded in a phase tuning structure, which is typically a medium that may change the refractive index based on the external control signal.

While an optical signal in a primary coupling section (118, 128, 138, 198) is evanescently coupled to another optical signal in a matching complementary coupling section (218, 228, 238, 298) in each pair of optically coupled sections (18, 28, 38, 98), optical signals are not evanescently coupled between a matching pair of a primary decoupled section (112, 122, 132, 192) and a complementary decoupled section (212, 222, 232, 292) in each pair of decoupled sections (12, 22, 32, 92). While it is known that quantum mechanical coupling between two wavefunctions may not reach a theoretical zero even at great distances, the effect of such coupling is astronomically small and decreases exponentially with distance, often decreasing by hundreds, thousands, or millions of orders of magnitude. For all practical purposes, such a small coupling is considered to be the same as a non-existent coupling for all practical purposes. Each of the primary waveguide 100 and the complementary waveguide 200 includes a curved portion in the pair of decoupled sections (12, 22, 32, 92) to gradually alter the path of the optical signals in the primary waveguide 100 and the complementary waveguide 200 while maintaining a total reflection condition for the optical signal, which is needed to confine the optical signals completely within the primary waveguide 100 and the complementary waveguide 200.

For any given wavelength for an optical signal, the phase change of the optical signal that propagates through any of the primary decoupled sections (112, 122, 132, 192) is constant irrespective of phase change in the optical signal that propagates through the complementary decoupled sections (212, 222, 232, 292). Each of the complementary decoupled sections (212, 222, 232, 292) is embedded in one of the phase tuning structures (13, 23, 33, 93). Each of the phase tuning structures (13, 23, 33, 93) modulates the phase change of an optical signal that propagates through the complementary decoupled section (212, 222, 232, 292).

For any given optical signal applied to the first optical input node 100 and having a predetermined wavelength, the quantum mechanical coupling at each of the pair of optically coupled sections (8, 18, 28, 38, 98) induces a wavefunction of the optical signal to be formed in the complementary waveguide 200 as well as in the primary waveguide 100. If the two wavefunctions destructively interfere at the end of the n-th primary coupling section 198 that is proximate to the first optical output node 199, a negligible output of the optical signal is provided at the first optical output node 199. If the two wavefunctions constructively interfere at the end of the n-th primary coupling section 198 that is proximate to the first optical output node 199, a significant output of the optical signal is provided at the first optical output node 199 that may be comparable with the optical input signal provided to the first optical input node 101 in terms of intensity. Likewise, if the two wavefunctions destructively interfere at the end of the n-th complementary coupling section 298 that is proximate to the second optical output node 299, a negligible output of the optical signal is provided at the second optical output node 299. If the two wavefunctions constructively interfere at the end of the n-th complementary coupling section 298 that is proximate to the second optical output node 299, a significant output of the optical signal is provided at the second optical output node 299 that may be comparable with the optical input signal provided to the first optical input node 101 in terms of intensity.

The first exemplary optical switch can also provide a switching function for an optical signal provided to the second optical input node 200. For any given optical signal applied to the second optical input node 200 and having a predetermined wavelength, the quantum mechanical coupling at each of the pair of optically coupled sections (8, 18, 28, 38, 98) induces a wavefunction of the optical signal to be formed in the primary waveguide 100 as well as in the complementary waveguide 200. The output of the optical signal at the first optical output node 199 and the second optical output node 299 are determined in the same manner as described above depending on whether the two wavefunctions interfere constructively or destructively at the end of the n-th primary coupling section 198 that is proximate to the first optical output node 199 and at the end of the n-th complementary coupling section 298 that is proximate to the second optical output node 299. Thus, the first exemplary optical switch of the present invention functions as a 2×2 optical signal switch shown in FIG. 2.

In general, an optical input signal may be applied to the first optical input node 101 or the second optical input node 201. In either case, the ratio of intensity of a first optical output signal at the first optical output node 199 to intensity of a second optical output signal at the second optical output node 299 is altered by the modulating of the phase changes to the optical signal that passes through the phase tuning structures (13, 23, 33, 93). The phase tuning structures (13, 23, 33, 93) includes a first phase tuning structure 13, a second phase tuning structure 23, a third phase tuning structure 33, and an n-th phase tuning structure 93. Each phase tuning structure (13, 23, 33, 93) includes at least one semiconductor device that alters the refractive index of the semiconductor material constituting the complementary decoupled section (212, 222, 232, 292) therein.

For any optical signal of a given wavelength that travels through the primary waveguide 100 and the complementary waveguide 200, the phase change of a wavefunction of the optical signal in the primary waveguide 100 remains constant, while the phase change of another wavefunction of the optical signal in the complementary waveguide 200 is modulated through the changes in the refractive index of the material constituting the complementary decoupled sections (212, 222, 232, 292) of the complementary waveguide 200.

The alteration of the refractive index may be effected by changing charge carrier concentration in the semiconductor material constituting the complementary decoupled sections (212, 222, 232, 292) of the complementary waveguide 200. Alternately, the alteration of the refractive index may be effected by changing the temperature of the semiconductor material constituting the complementary decoupled sections (212, 222, 232, 292) of the complementary waveguide 200.

The first exemplary optical switch employs the charge carrier concentration in the semiconductor material constituting the complementary decoupled sections (212, 222, 232, 292) of the complementary waveguide 200 as a tuning parameter for the phase change of the wavefunction of the optical signal in the complementary waveguide 200. Each phase tuning structure (13, 23, 33, 93) employs a (p-type)-intrinsic-(n-type) (PIN) diode or a (p-type)-(n-type) (PN) diode. A PIN diode comprises an intrinsic semiconductor portion that includes a complementary decoupled section (212, 222, 232, or 292) and abutting a p-type semiconductor portion and an n-type semiconductor portion. For example, the first complementary decoupled section 212 may laterally abut a first p-type semiconductor portion 14 and a first n-type semiconductor portion 16. Other complementary decoupled sections (222, 232, 292) may have a similar configuration in which each of the complementary decoupled sections (222, 232, 292) is laterally abutted by a p-type semiconductor portion and an n-type semiconductor portion.

Within each phase tuning structure (13, 23, 33, 93), the complementary decoupled sections (212, 222, 232, 292) are defined by patterning the semiconductor material constituting the complementary waveguide 200. The volume that is not occupied by the semiconductor material is typically filled with a dielectric material to form dielectric material portions (17, 27, 37, 97). Contact via structures are formed directly on the p-type semiconductor portions and the n-type semiconductor portions to enable operation of the PIN diodes, i.e., to enable passing of the current through the PIN diodes. For example, a first contact via structure 19A may be formed directly on the first p-type semiconductor portion 14 and a second contact via structure 19B may be formed directly on the p-type semiconductor portion 16.

The PIN diodes are integrally formed with the complementary decoupled sections (212, 222, 232, 292) of the complementary waveguide 200. As electrical current passes through the intrinsic semiconductor portions, which are the complementary decoupled sections (212, 222, 232, 292) of the PIN diodes, the charge carrier concentration in the complementary decoupled sections (212, 222, 232, 292) of the complementary waveguide 200 increases, thereby altering the refractive index of the semiconductor material constituting the complementary decoupled sections (212, 222, 232, 292). The phase change of the wavefunction of the optical signal that propagates through the complementary waveguide 200 is modulated with the electrical signal applied to the PIN diodes through the amount of current that passes through the PIN diodes.

In case a PN diode is employed instead of a PIN diode, a vertical PN junction may be formed between a p-type semiconductor portion and an n-type semiconductor portion that extend into the complementary decoupled sections (212, 222, 232, 292). In this case, each of the complementary decoupled sections (212, 222, 232, 292) include a vertical PN junction and does not include an intrinsic semiconductor material portion. Charge carrier concentration is normally high in the absence of any electrical bias in this case. When the PN diode is reverse biased, a depletion region is formed within the complementary decoupled section. In other words, one could also lower the carrier concentration by reverse-biasing a PN diode, thereby depleting the carriers in the waveguide region. Using a PIN diode for carrier injection yields switching speeds in the nanosecond range, which is at least three orders of magnitude faster than a typical switching speed of a thermally activated switch.

In general, the interference of the two wavefunctions of the optical signal may interfere constructively, destructively, or at any relative phase differences between constructive and destructive interferences at the end of the n-th primary coupling section 198 that is proximate to the first optical output node 199 and at the end of the n-th complementary coupling section 298 that is proximate to the second optical output node 299. The first exemplary optical switch may be employed to select an output node at which the predominant portion of the energy associated with the optical input signal into one of the first optical input node 101 and the second optical input node 201. The unselected output node provides an insignificant portion of the energy associated with the optical input signal.

In some cases, an optical input signal may be applied to the first optical input node 101 and another optical input signal may be applied to the second optical input node 201. In this case, the first exemplary optical switch may be employed to channel the two optical input signals at the same time. For example, the first exemplary optical switch may be set to channel the optical input signal to the first optical input node 101 to the first optical output node 199 and to channel the optical input signal to the second optical input node 201 to the second optical output node 299. Alternately, the first exemplary optical switch may be set to channel the optical input signal to the first optical input node 101 to the second optical output node 299 and to channel the optical input signal to the second optical input node 201 to the first optical output node 199.

While the present invention is described with semiconductor devices configured to induce changes in the charge carrier concentration in the complementary decoupled sections (212, 222, 232, 292) of the complementary waveguide 200, embodiments in which the refractive index of the complementary decoupled sections (212, 222, 232, 292) is altered by other means are explicitly contemplated. For example, the change in the refractive index may be effected by a change in temperature in the semiconductor material constituting the complementary decoupled sections (212, 222, 232, 292).

The use of multiple stages of cascaded optical interferometric structures (10, 20, 30, 90) allows a wider window in terms of tuning parameters for the semiconductor devices that affect the refractive index of the complementary decoupled sections (212, 222, 232, 292) of the complementary waveguide 200.

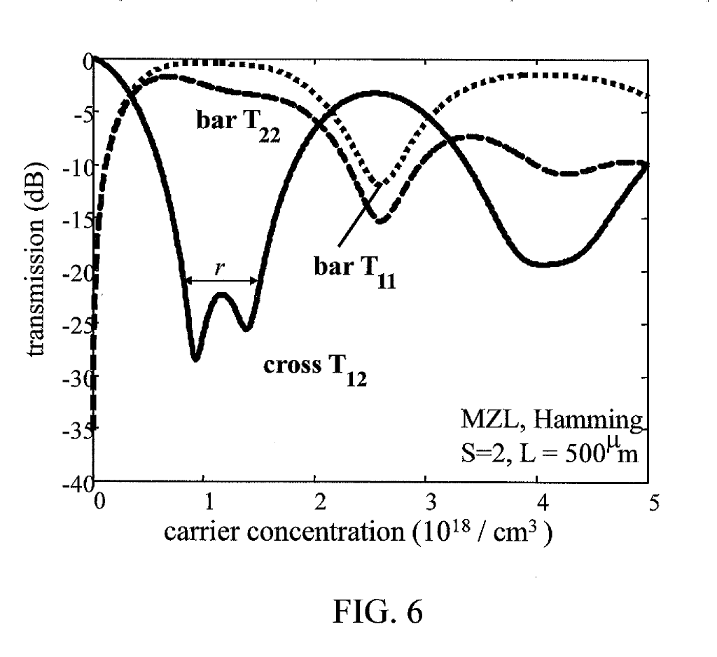

Referring to FIG. 6, simulation results for bar transmission characteristics and cross transmission characteristics are shown for an optical switch having two stages of optical interferometric structures according to the present invention. The optical switch simulated here may be derived from the first exemplary optical switch described in FIGS. 4 and 5 by omitting the second optical interferometric structure 20 and the third optical interferometric structure 30, and by connecting the n-th optical interferometric structure 90 directly to the first optical interferometric structure 10.

The fraction of a first input signal applied to the first optical input node 101 (See FIGS. 4 and 5) that is transmitted to the first output signal node 199 is represented by a first bar transmission coefficient T₁₁. The fraction of the first input signal applied to the first optical input node 101 that is transmitted to the second output signal node 299 is represented by a first cross transmission coefficient T₁₂. The fraction of a second input signal applied to the second optical input node 201 that is transmitted to the first output signal node 199 is represented by a second cross transmission coefficient T₂₁.

The various transmission coefficients may be modulated by altering the phase change of the optical signal in the complementary decoupled sections (212, 292). The phase change of the optical signal through the second optical path depends on that change in the refractive index in the phase tuning structures (13, 93) triggered by an external control signal. The change in the refractive index is proportional to the charge carrier concentration in the complementary decoupled sections (212, 292). The first bar transmission coefficient T₁₁, the first cross transmission coefficient T₁₂, and the second cross transmission coefficient T₂₁ is a complicated function of the phase change of the optical signal in the complementary decoupled sections (212, 292).

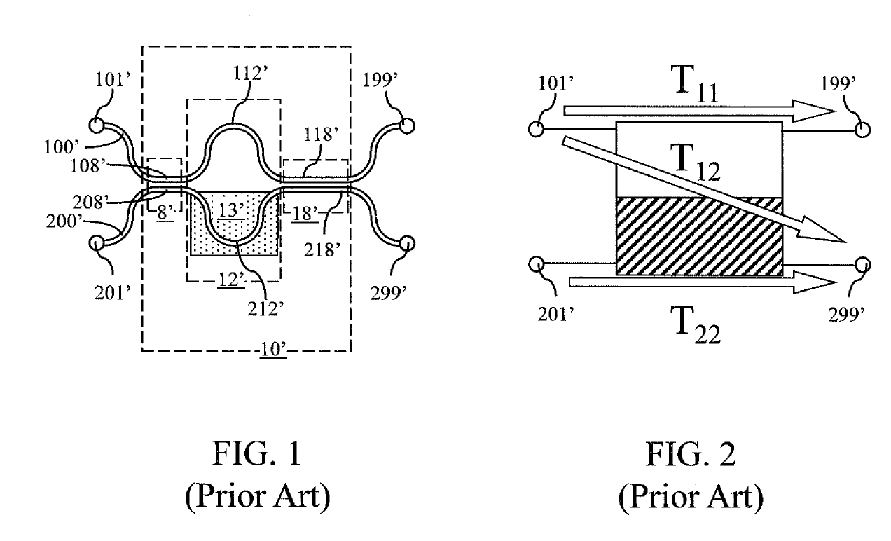

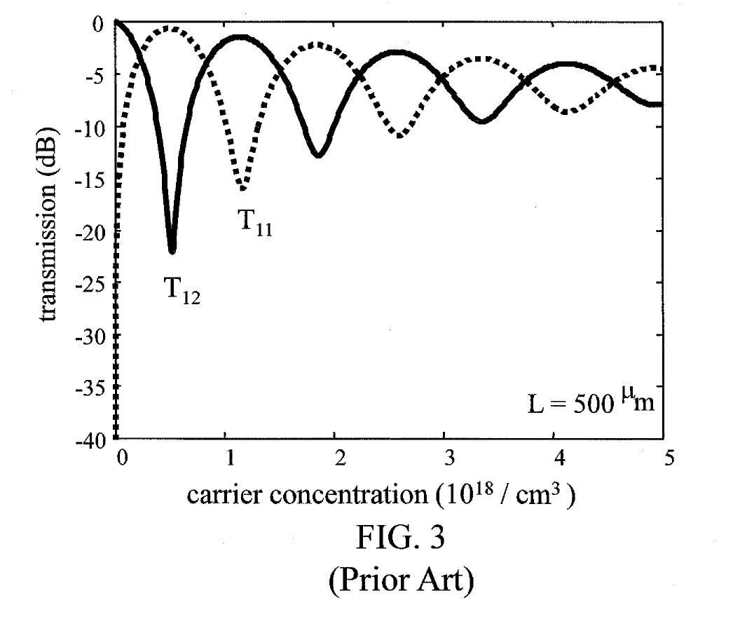

One noteworthy feature of the graph is the range r in the charge carrier concentration graph within which the first cross transmission coefficient T₁₂ is less than −20 dB, i.e., the magnitude of the output signal from the second output signal node 299 is at least an order of magnitude smaller than the magnitude of the input signal into the first input signal node 101. Compared with the range of the charge carrier concentration (See FIG. 3) that allows such suppression of the output signal from the second output signal node 299 for the same input signal in the prior art optical switch of FIG. 1, the range r in the charge carrier concentration is much wider for the optical switch of the present invention even when the total number of optical interferometric structures is 2 in the cascaded plurality of optical interferometric structures. Thus, superior controllability is achieved with the optical switch of the present invention.

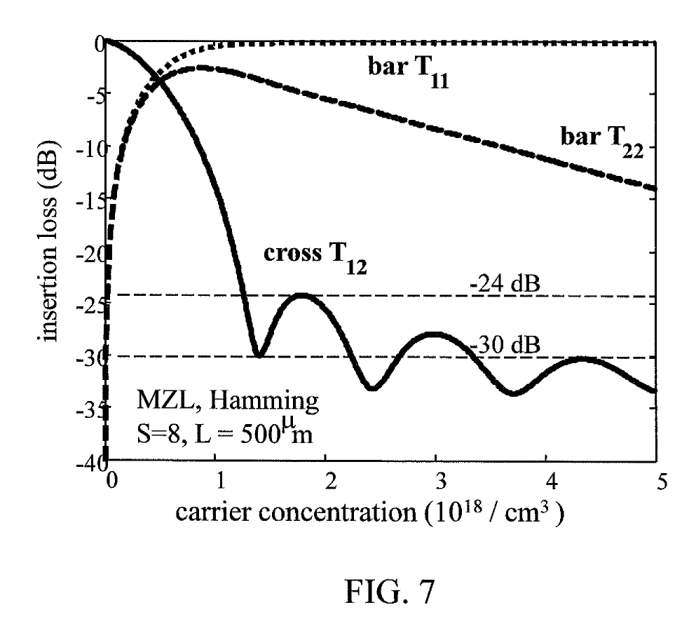

Referring to FIG. 7, simulation results for bar transmission characteristics and cross transmission characteristics are shown for an optical switch having 9 stages of optical interferometric structures according to the present invention. The optical switch simulated here may be derived from the first exemplary optical switch described in FIGS. 4 and 5 by inserting 5 more instances of an optical interferometric structure (e.g., a second optical interferometric structure 20) between the third optical interferometric structure 30 and the n-th optical interferometric structure 90.

Additional stages of optical interferometric structures decrease the first cross transmission coefficient T₁₂ to a level that is not enabled by the exemplary prior art optical switch of FIG. 1, if operated with the fast carrier-injection phase tuning mechanism. For example, the first cross transmission coefficient T₁₂ may be at −24 dB or less for charge carrier concentration greater than 1.2×10¹⁸/cm³, and may be less than −30 dB or less for some charge carrier concentration ranges.

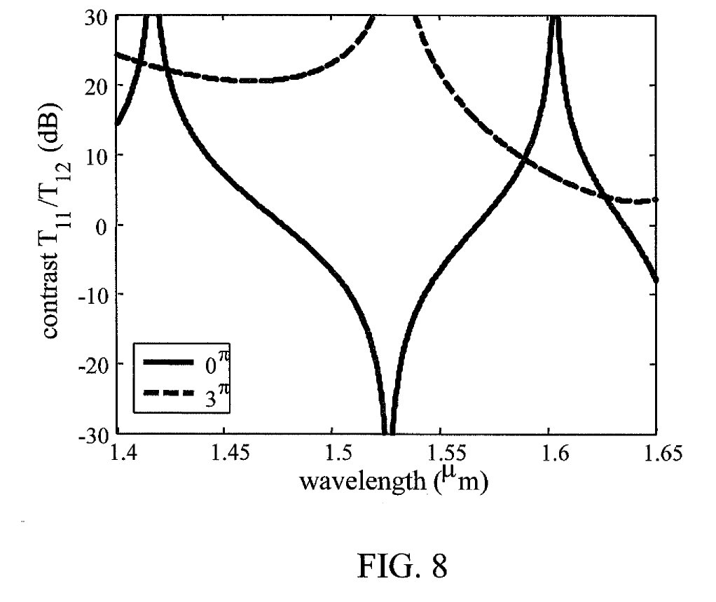

Referring to FIG. 8, simulation results for the ratio T₁₁/T₁₂ are shown for an optical switch having eight stages of optical interferometric structures. The optical switch simulated in FIG. 8 is configured to provide a complete cross transmission and zero bar transmission at a wavelength of 1.525 micron when there is no additional phase modulation in each pair of decoupled sections by phase tuning structures, e.g., the current is zero in all PIN diodes. In other words, if an optical signal having a wavelength of 1.525 micron is applied to the first optical input node 101 (See FIGS. 4 and 5) in the absence of any additional phase modulation in each pair of decoupled sections by the phase tuning structures, all output signal is directed to the second optical output node 299 and no output signal comes out of the first optical output node 199. This state is referred to as a non-phase-tuned state. This state is represented by the solid line labeled 0π. At 1.525 micron, the ratio T₁₁/T₁₂ is less than −30 dB (theoretically −∞).

By altering the refractive index of the complementary decoupled sections (212, 292; see FIGS. 4 and 5), the phase difference between a first wavefunction of the optical signal in the primary waveguide 100 and a second wavefunction of the optical signal in the complementary waveguide 200 may be shifted. The ratio T₁₁/T₁₂ for a phase-tuned state in which the two phases are modulated by 3π is shown by a dotted line labeled 3π. At 1.525 micron wavelength, the ratio T₁₁/T₁₂ is greater than 30 dB. In other words, if an optical signal having a wavelength of 1.525 micron is applied to the first optical input node 101 (See FIGS. 4 and 5) in the presence of cumulative additional phase modulation of 3π in the pairs of decoupled sections by the phase tuning structures, most output signal is directed to the first optical output node 199 and only an insignificant amount of output signal comes out of the second optical output node 299. The ratio of the two output signals exceeds 30 dB in this case.

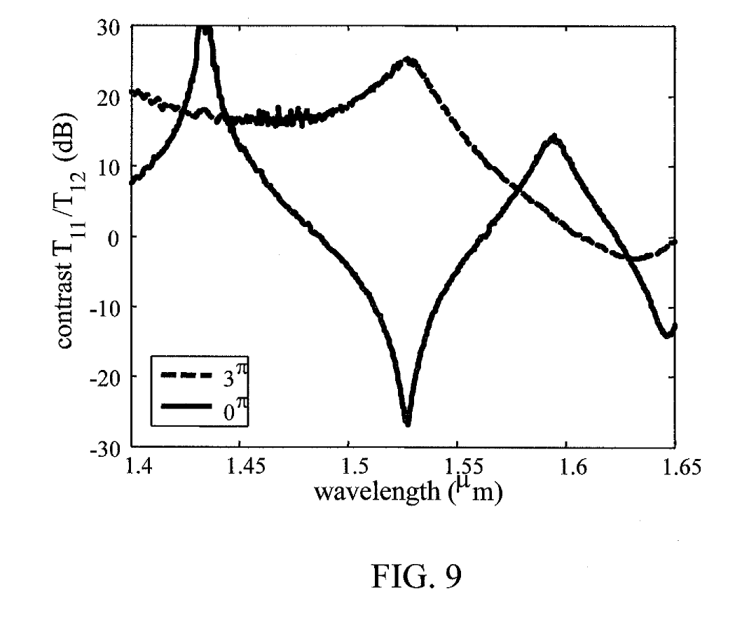

Referring to FIG. 9, measured data for the ratio T₁₁/T₁₂ is shown for the optical switch having eight stages of optical interferometric structures. The data in FIG. 9 corresponds to the simulation results of FIG. 8 qualitatively. Deviations from the simulation results of FIG. 8 are due to imperfections in the physical implementation of the model used in FIG. 8 and other physical parameters ignored for the simulation results of FIG. 8. The measured data shows the ratio T₁₁/T₁₂ of about −28 dB for the non-phase-tuned state in which the output signal is predominantly directed to the second optical output node 299 (See FIGS. 4 and 5) for the optical input applied to the first optical input node 101 and having a wavelength of 1.525 micron, and the ratio T₁₁/T₁₂ of about 25 dB for the phase-tuned state in which the output signal is predominantly directed to the first optical output node 199 (See FIGS. 4 and 5) for the optical input applied to the first optical input node 101 and having a wavelength of 1.525 micron. The measured data shows a dynamic range of about 53 dB for the exemplary optical switch of the present invention for the case of eight cascaded optical interferometric structures.

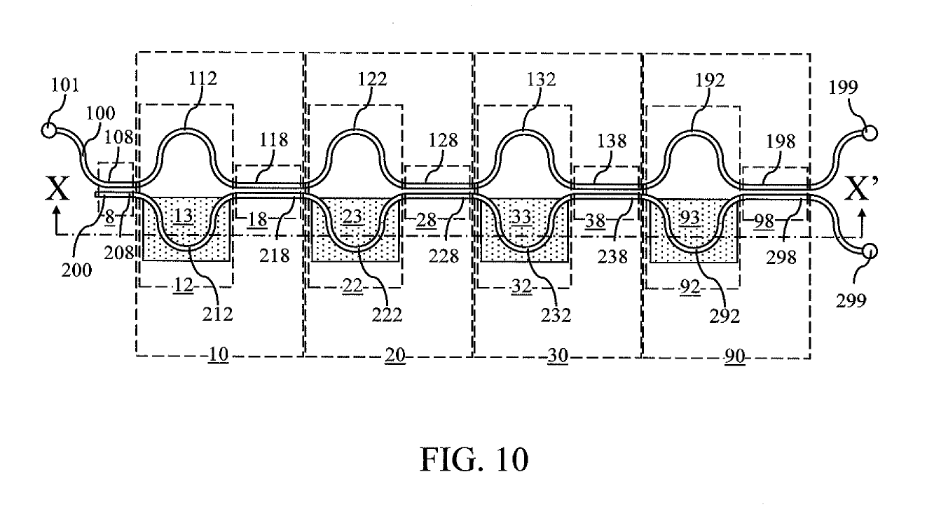

Referring to FIG. 10, a second exemplary optical switch according to a second embodiment of the present invention is shown. The second exemplary optical switch may be derived form the first exemplary optical switch of the first embodiment as shown in FIGS. 4 and 5 by eliminating the second optical input node 201 and a section of the complementary waveguide 200 between the second optical input node 201 and the initial pair of optically coupled sections 8. In this case, the second exemplar optical switch functions as a 1×2 optical switch, i.e., an optical switch having one input node and two output nodes. A first bar transmission coefficient T₁₁ and a first cross transmission coefficient T₁₂ are defined in the same manner as in the first embodiment. The first bar transmission coefficient T₁₁ and the first cross transmission coefficient T₁₂ have the same characteristics as in the first embodiment.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. An optical switch comprising:
a plurality of optical interferometric structures in a cascaded connection, wherein each optical interferometric structure includes a pair of optically coupled sections and a pair of decoupled sections, wherein each pair of optically coupled sections includes a primary coupling section and a complementary coupling section that are evanescently coupled to each other, each pair of decoupled sections includes a primary decoupled section and a complementary decoupled section that are not evanescently coupled to each other, wherein said primary coupling sections and said primary decoupled sections are contiguously connected to constitute a primary waveguide embedded in a top semiconductor layer of a semiconductor-on-insulator substrate, and said complementary coupling sections and said complementary decoupled sections are contiguously connected to constitute a complementary waveguide embedded in said top semiconductor layer of said semiconductor-on-insulator substrate, and wherein said plurality of optical interferometric structures are not identical among one another by having different lengths among said decoupled sections, whereby position and amplitude of sidelobes of switching characteristics of said optical switch deviates from position and amplitude of sidelobes of switching characteristics of another optical switch having identical cascaded replicas of optical interferometric structures, whereby an optical bandwidth of said optical switch is greater than a corresponding optical bandwidth of said another optical switch;
a first optical input node and a first optical output node, each connected to an end of said primary waveguide; and
a second optical output node connected to an end of said complementary waveguide.

2. (canceled)

3. The optical switch of claim 1, wherein said pair of decoupled sections further includes a primary decoupled section that is a portion of said primary waveguide, and wherein a phase change of an optical signal that propagates through said primary decoupled section is constant irrespective of phase change in an optical signal that propagates through said complementary decoupled section.

4. The optical switch of claim 1, wherein said phase tuning structure includes at least one semiconductor device that alters a refractive index of a semiconductor material constituting said complementary decoupled section.

5. The optical switch of claim 4, wherein said refractive index is altered by a change in a charge carrier concentration in said semiconductor material.

6. (canceled)

7. The optical switch of claim 28, wherein said at least one semiconductor device is a combination of a PIN diode integrally formed with said complementary decoupled section and another semiconductor device located on said semiconductor substrate and configured to provide electrical current through said PIN diode.

8. The optical switch of claim 4, wherein said refractive index is altered by a change in temperature in said semiconductor material.

9. The optical switch of claim 1, wherein said section of said primary waveguide is separated from said section of said complementary waveguide by a substantial constant separation distance in said pair of optically coupled sections.

10. (canceled)

11. The optical switch of claim 9, wherein each of said primary waveguide and said complementary waveguide includes a curved portion in said pair of decoupled sections.

12. The optical switch of claim 1, wherein an entirety of a top surface of said primary waveguide and an entirety of a top surface of said complementary waveguide are coplanar with each other.

13-14. (canceled)

15. The optical switch of claim 1, wherein each of said primary waveguide and said complementary waveguide comprise a same semiconductor material as said semiconductor substrate.

16. The optical switch of claim 15, wherein said primary waveguide is contiguous between said first optical input node and said first optical output node and has a substantially constant cross-sectional area between said first optical input node and said first optical output node.

17. The optical switch of claim 1, further comprising a second optical input node directly connected to said complementary waveguide.

18. The optical switch of claim 17, wherein said complementary waveguide is contiguous between said second optical input node and said second optical output node and has a substantially constant cross-sectional area between said second optical input node and said second optical output node.

19. A method of operating an optical switch comprising:
providing an optical switch including:
a plurality of optical interferometric structures in a cascaded connection, wherein each optical interferometric structure includes a pair of optically coupled sections and a pair of decoupled sections, wherein each pair of optically coupled sections includes a primary coupling section and a complementary coupling section that are evanescently coupled to each other, each pair of decoupled sections includes a primary decoupled section and a complementary decoupled section that are not evanescently coupled to each other, wherein said primary coupling sections and said primary decoupled sections are contiguously connected to constitute a primary waveguide embedded in a top semiconductor layer of a semiconductor-on-insulator substrate, and said complementary coupling sections and said complementary decoupled sections are contiguously connected to constitute a complementary waveguide embedded in said top semiconductor layer of said semiconductor-on-insulator substrate, and wherein said plurality of optical interferometric structures are not identical among one another by having different lengths among said decoupled sections, whereby position and amplitude of sidelobes of switching characteristics of said optical switch deviates from position and amplitude of sidelobes of switching characteristics of another optical switch having identical cascaded replicas of optical interferometric structures, whereby an optical bandwidth of said optical switch is greater than a corresponding optical bandwidth of said another optical switch;
a first optical input node and a first optical output node, each connected to an end of said primary waveguide; and
a second optical output node connected to an end of said complementary waveguide; and
modulating a phase change of an optical signal in said complementary waveguide by altering a refractive index of a semiconductor material in a plurality of said pairs of said optically coupled sections, whereby a ratio of a first bar transmission coefficient to a first cross transmission coefficient is altered by said modulating of said phase change, wherein said first bar transmission coefficient is a fraction of a first input signal applied to said first optical input node that is transmitted to said first output signal node, and said first cross transmission coefficient is a fraction of said first input signal applied to said first optical input node that is transmitted to said second output signal node.

20. The method of claim 19, wherein a phase change of another optical signal in said primary waveguide remains constant during said modulating of said phase change of said optical signal in said complementary waveguide.

21. The method of claim 19, wherein said altering of said refractive index is effected by comprising a changing charge carrier concentration said semiconductor material.

22. The method of claim 21, wherein each of said plurality of optical interferometric structures includes a (p-type)-intrinsic-n-type) (PIN) diode comprising an intrinsic semiconductor portion embedding a portion of said complementary waveguide and abutting a p-type semiconductor portion and an n-type semiconductor portion, wherein said intrinsic semiconductor portion includes said semiconductor material.

23. (canceled)

24. The method of claim 19, wherein said optical switch further includes a second optical input node directly connected to said complementary waveguide, wherein said method further comprises applying an optical input signal to said second optical input node, and wherein a ratio of intensity of a first optical output signal at said first optical output node to intensity of a second optical output signal at said second optical output node is altered by said modulating of said phase change.

25-27. (canceled)

28. The optical switch of claim 1, wherein each of said complementary decoupled section is embedded in a PIN diode such that an intrinsic semiconductor portion of said PIN diode laterally extends at least from one sidewall of a semiconductor structure to another sidewall of said semiconductor structure and constitutes an entirety of a complementary decoupled section, and said complementary decoupled section does not include a p-doped semiconductor portion or an n-doped semiconductor portion.

29. The method of claim 19, each of said complementary decoupled section is embedded in a PIN diode such that an intrinsic semiconductor portion of said PIN diode laterally extends at least from one sidewall of a semiconductor structure to another sidewall of said semiconductor structure and constitutes an entirety of a complementary decoupled section, and said complementary decoupled section does not include a p-doped semiconductor portion or an n-doped semiconductor portion.
